(19) United States
(12) Patent Application Publication
(10) Pub. No.: US 2026/0024169 A1
(43) Pub. Date: Jan. 22, 2026

(54) IMAGE PROCESSING DEVICE, IMAGE PROCESSING METHOD, AND RECORDING MEDIUM

(71) Applicant: OLYMPUS CORPORATION, Tokyo (JP)

(72) Inventor: Teruaki YAMASAKI, Tokyo (JP)

(73) Assignee: OLYMPUS CORPORATION, Tokyo (JP)

(21) Appl. No.: 19/272,060

(22) Filed: Jul. 17, 2025

Related U.S. Application Data
(63) Continuation of application No. PCT/JP2023/001610, filed on Jan. 20, 2023.

(51) Int. Cl. G06T 5/50; G06T 5/90

(52) U.S. Cl. CPC G06T 5/50; G06T 5/90; G06T 2207/20221

(57) ABSTRACT

Provided is an image processing device including a processor. The processor is configured to receive a far-point image focused at a far point and a near-point image focused at a near point. The far-point image and the near-point image have different exposure amounts from each other. Subsequently, the processor is configured to generate a determination map representing brightness or frequencies of respective regions of one of the far-point image and the near-point image, calculate combining ratios of the far-point image and the near-point image for the respective regions on the basis of the determination map and a prescribed relationship between a combining ratio and brightness or a frequency, and combine the far-point image and the near-point image by using the combining ratios calculated for the respective regions.

### CROSS-REFERENCE TO RELATED APPLICATIONS

This is a continuation of International Application PCT/JP2023/001610 which is hereby incorporated by reference herein in its entirety.

### TECHNICAL FIELD

The present invention relates to an image processing device, an image processing method, and a recording medium.

### BACKGROUND ART

In the related art, there is a known technology of generating an extended depth-of-field (EDOF) image and a high dynamic range (HDR) image (for example, see Patent Literatures 1 and 2). The EDOF image is an image in which the depth of field is extended, obtained by combining a plurality of images having different focal distances. The HDR image is an image in which the dynamic range is extended, obtained by combining a plurality of images having different exposure amounts.

Patent Literatures 1 and 2 each propose a technology for generating, from a plurality of images in which both the focal distances and exposure amounts are different from each other, an EDOF+HDR image in which both the depth of field and dynamic range are extended. In Patent Literature 1, a near-point image having a small exposure amount and a far-point image having a large exposure amount are acquired by adjusting the ratio of the exposure amount between the near-point image and the far-point image by means of a dimming mirror. In Patent Literature 2, a plurality of images having different optical distances and brightness are acquired by splitting incident light.

### CITATION LIST

### Patent Literature

{PTL 1} Publication of Japanese Patent No. 5856733
{PTL 2} PCT International Publication No. WO 2018/221041

### SUMMARY OF INVENTION

An aspect of the present invention is an image processing device including a processor, wherein the processor is configured to: receive a far-point image focused at a far point and a near-point image focused at a near point, the far-point image and the near-point image having different exposure amounts from each other; generate a determination map representing brightness or frequencies of respective regions of one of the far-point image and the near-point image; calculate combining ratios of the far-point image and the near-point image for the respective regions on the basis of the determination map and a prescribed relationship between a combining ratio and brightness or a frequency; and combine the far-point image and the near-point image by using the combining ratios calculated for the respective regions.

Another aspect of the present invention is an image processing method including: receiving a far-point image focused at a far point and a near-point image focused at a near point, the far-point image and the near-point image having different exposure amounts from each other; generating a determination map representing brightness or frequencies of respective regions of one of the far-point image and the near-point image; calculating combining ratios of the far-point image and the near-point image for the respective regions on the basis of the determination map and a prescribed relationship between a combining ratio and brightness or a frequency; and combining the far-point image and the near-point image by using the combining ratios calculated for the respective regions.

Another aspect of the present invention is a computer-readable non-transitory recording medium in which an image processing program is recorded, wherein the image processing program causes a computer to execute: receiving a far-point image focused at a far point and a near-point image focused at a near point, the far-point image and the near-point image having different exposure amounts from each other; generating a determination map representing brightness or frequencies of respective regions of one of the far-point image and the near-point image; calculating combining ratios of the far-point image and the near-point image for the respective regions on the basis of the determination map and a prescribed relationship between a combining ratio and brightness or a frequency; and combining the far-point image and the near-point image by using the combining ratios calculated for the respective regions.

### BRIEF DESCRIPTION OF DRAWINGS

FIG. 1 is a configuration diagram of an image processing device according to an embodiment of the present invention.

FIG. 2A is a graph showing an example of a relationship between brightness and a combining ratio.

FIG. 2B is a graph showing an example of a relationship between a frequency and a combining ratio.

FIG. 2C is a graph showing another example of the relationship between a frequency and a combining ratio.

FIG. 3A is a flowchart of an image processing method according to an embodiment of the present invention.

FIG. 3B is a flowchart showing step S2 in the image processing method in FIG. 3A.

FIG. 4A is a diagram showing an example of a far-point image or a near-point image.

FIG. 4B is a diagram showing a determination map generated from the image in FIG. 4A.

FIG. 5 is a diagram for explaining another method of calculating combining ratios for respective regions.

FIG. 6A is a flowchart of an image processing method according to another embodiment of the present invention.

FIG. 6B is a flowchart showing step S4 and step S5 in the image processing method in FIG. 6A.

FIG. 7 is a graph showing another example of the relationship between a frequency and a combining ratio.

FIG. 8 is a graph showing another example of the relationship between brightness and a combining ratio.

FIG. 9 is a diagram for explaining a method of adjusting the relationship between brightness and a combining ratio.

### DESCRIPTION OF EMBODIMENT

An image processing device, an image processing method, and a recording medium according to an embodiment of the present invention will be described below with reference to the drawings.

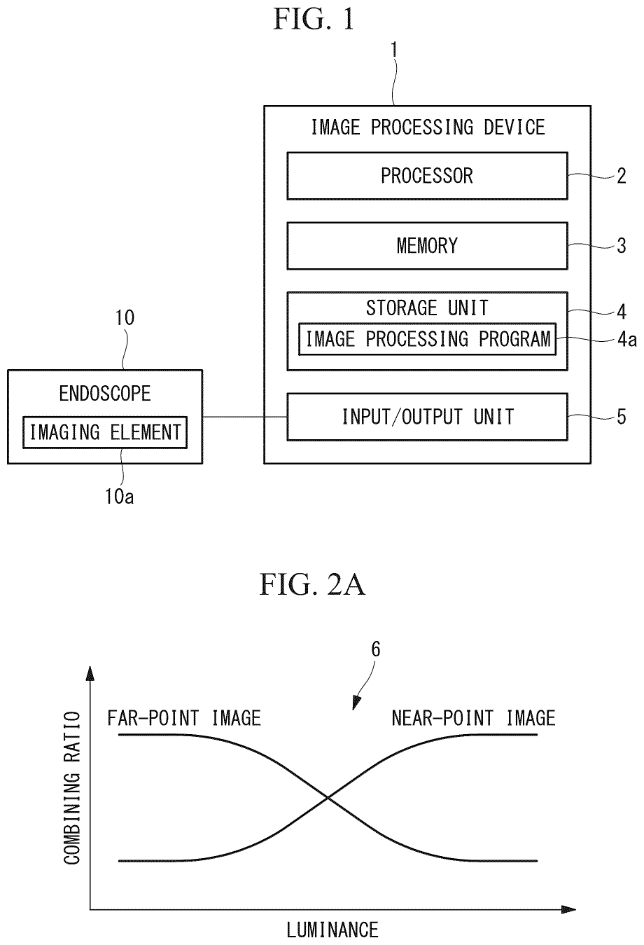

An image processing device 1 according to this embodiment has a function of combining a plurality of images, thereby generating an EDOF+HDR image in which both the depth of field and dynamic range are extended as compared with each of the plurality of images. As shown in FIG. 1, the image processing device 1 includes a processor 2 such as a central processing unit, a memory 3, a storage unit 4, and an input/output unit 5.

The image processing device 1 is, for example, incorporated as a part of an endoscope system. The input/output unit 5 has a publicly known input/output interface, and the image processing device 1 receives an image acquired by an endoscope 10 through the input/output unit 5.

The endoscope 10 has an imaging element 10a, such as a CMOS image sensor or a CCD image sensor, and acquires a far-point image and a near-point image of a subject by means of the imaging element 10a. The far-point image is an image focused at a far point, and the near-point image is an image focused at a near point. Therefore, the far-point image and the near-point image have different focal distances from each other. Furthermore, the far-point image and the near-point image have different exposure amounts from each other.

As described above, the far-point image and the near-point image in which both the focal distances and exposure amounts are different from each other are acquired by using a publicly known means.

In an example, the far-point image and the near-point image are sequentially acquired as a result of the imaging element 10a continuously shooting the subject under different exposure conditions. The exposure condition is, for example, a light intensity of a light source, a shutter speed of the imaging element 10a, or a gain.

In another example, the far-point image and the near-point image are simultaneously acquired as a result of the imaging element 10a single-shooting the subject. In this case, an imaging optical system of the endoscope 10 may include, at a preceding stage of the imaging element 10a, a prism that splits light from the subject into two light beams. The prism gives mutually different optical path lengths to the two light beams, and one or two imaging elements 10a simultaneously capture images of the two light beams.

In order to achieve different exposure amounts, the prism may split the light from the subject into two light beams having different light intensities from each other. The split ratio of light is adjusted by, for example, a coating agent applied to the prism. Alternatively, the imaging optical system may include two circuits connected to individual pixels of the imaging element 10a. The individual pixels output signals to the two circuits, and an image in which a gain is not applied is acquired from one circuit and an image in which a gain is applied is acquired from the other circuit.

The memory 3 is composed of a volatile storage device such as a RAM, and is used as a work area of the processor 2.

The storage unit 4 is composed of a computer-readable non-transitory recording medium such as, for example, a ROM, a flash memory, or a hard disk drive.

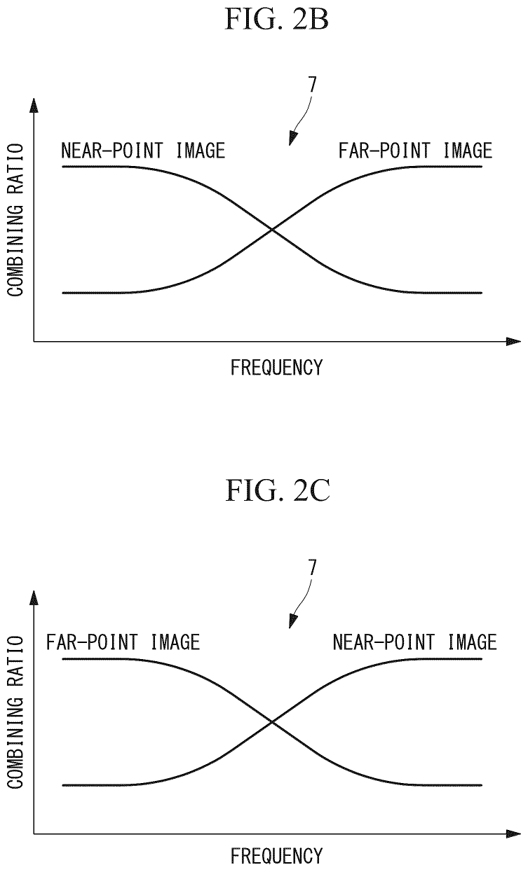

The storage unit 4 stores an image processing program 4a for causing the processor 2 to execute an image processing method, which will be described later. Furthermore, as shown in FIGS. 2A, 2B, and 2C, the storage unit 4 stores prescribed relationships 6, 7 used for the combining of a far-point image and a near-point image in the image processing method. FIG. 2A shows an example of the prescribed relationship 6 between brightness and a combining ratio, and FIGS. 2B and 2C each show an example of the prescribed relationship 7 between a frequency and a combining ratio. The relationships 6, 7 are, for example, experimentally determined in advance on the basis of images of a subject acquired by the endoscope. Note that, in the present specification, the frequency is a spatial frequency of an image.

Next, the image processing method executed by the processor 2 will be described.

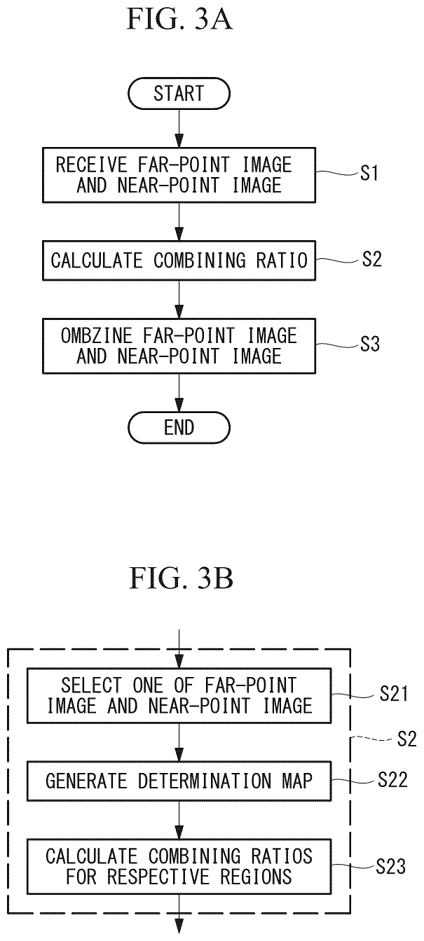

As shown in FIG. 3A, the image processing method includes: step S1 of receiving a far-point image and a near-point image; step S2 of calculating a combining ratio of the far-point image and the near-point image; and step S3 of combining the far-point image and the near-point image on the basis of the combining ratio to generate an EDOF+HDR image.

As shown in FIG. 3B, step S2 includes steps S21, S22, and S23. Upon receiving a pair of far-point image and near-point image from the endoscope 10 (step S1), the processor 2 selects one of the far-point image and the near-point image (step S21). In step S21, the processor 2 may select an image having a smaller number of overexposed pixels, in which luminance values thereof are saturated, or underexposed pixels, or may select a preset image.

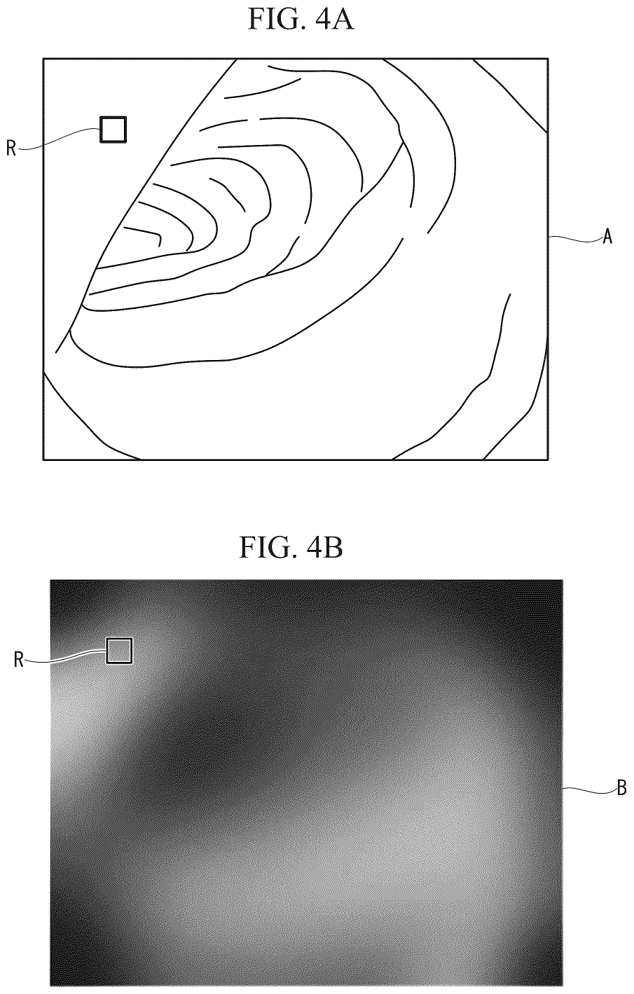

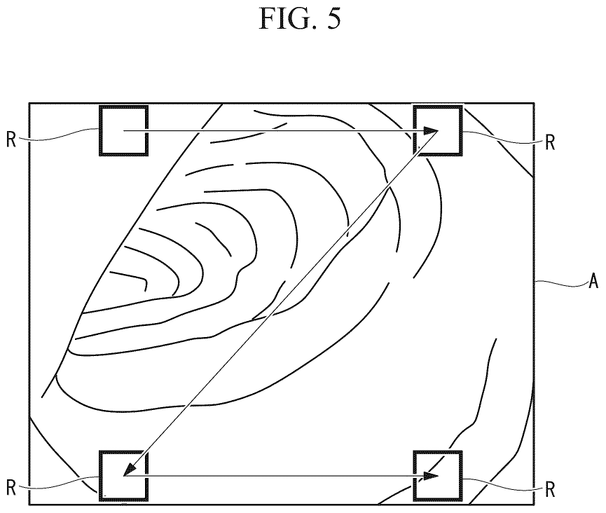

Next, the processor 2 generates a determination map representing brightness of respective regions in the selected image (step S22). Specifically, the processor 2 generates a luminance image of the selected image A, calculates low-frequency components of the luminance image by applying a publicly known low-pass filter, such as a Gaussian filter, to the luminance image, and generates a determination map representing the low-frequency components of respective regions in the image A. FIG. 4A shows a far-point image or a near-point image, which is the selected image A, and FIG. 4B shows a determination map B generated from the image A in FIG. 4A. The determination map B is an image in which fine spatial changes in the brightness, based on a fine structure of a subject, are removed and that represents rough spatial changes in the brightness in the image A.

Next, the processor 2 calculates combining ratios of the far-point image and the near-point image for respective regions R on the basis of the determination map B and the relationship 6 (step S23). The region R is a region comprising one pixel or a plurality of pixels. In the case in which the region R comprises a plurality of pixels, a value of the region R is, for example, an average of values of the plurality of pixels. Specifically, the processor 2 calculates, from the relationship 6, combining ratios corresponding to low-frequency component values (luminance) of respective regions R in the determination map B. In a scene of a lumen such as an intestinal tract, a region having a short subject distance is bright, and a region having a long subject distance is dark. The subject distance is a distance in an optical axis direction from the distal end of the endoscope 10 to a subject during image acquisition. In the relationship 6, the combining ratio of the near-point image increases as the luminance increases, and the combining ratio of the far-point image increases as the luminance decreases (see FIG. 2A).

Next, the processor 2 combines the far-point image and the near-point image by using the combining ratios calculated for the respective regions R in step S23 (step S3). Specifically, the processor 2 combines, at the calculated combining ratios, pixel values of individual pixels in the regions R at the corresponding positions in the far-point image and the near-point image. By doing so, the processor 2 simultaneously executes EDOF processing for extending the depth of field and HDR processing for extending the dynamic range, thereby generating an EDOF+HDR image.

After step S3, the processor 2 may output the EDOF+HDR image to an external device, for example, a display device, connected to the image processing device 1.

As described above, with this embodiment, the combining ratios are calculated for the respective regions R on the basis of the brightness of one of the far-point image and the near-point image. The brightness of an image of a subject such as a lumen is correlated with the subject distance, and in the far-point image and the near-point image, a region having a long subject distance is dark and a region having a short subject distance is bright. Therefore, it is possible to calculate appropriate combining ratios for the respective regions R on the basis of the brightness thereof. In addition, as a result of using such appropriate combining ratios, it is possible to generate a high-quality EDOF+HDR image that is well focused over a large depth of field.

In addition, with this embodiment, the combining ratios are calculated on the basis of the low-frequency components as the brightness of the image. The low-frequency components in which fine changes in the brightness, based on a fine structure of a subject, are removed represent more accurate subject distances. Therefore, it is possible to stably calculate appropriate combining ratios on the basis of the low-frequency components.

In addition, with this embodiment, as a result of generating the determination map B, the low-frequency components of all the regions R in the image A are calculated at once. With this configuration, it is possible to reduce the calculation amount and time pertaining to the calculation of the combining ratios for all the regions R.

In this embodiment, the processor 2 may generate a determination map representing frequencies of the image A instead of the determination map representing the brightness of the image A.

In this case, the processor 2 generates a luminance image of the image A, calculates high-frequency components of the luminance image by applying a publicly known high-pass filter to the luminance image, and generates a determination map representing the high-frequency components of the respective regions R in the image A (step S22).

Next, the processor 2 calculates combining ratios for the respective regions R on the basis of the relationship 7 and high-frequency component values of the respective regions R in the determination map (step S23).

In the case in which the determination map representing the frequency components is used, conditions are different between the far-point image and the near-point image.

In a case in which the selected image A is the far-point image, in a scene of a lumen, the structure of a subject is rough in a region having a short subject distance, and the structure of the subject is dense in a region having a long subject distance. Therefore, in the relationship 7, the combining ratio of the far-point image increases as the frequency increases, and the combining ratio of the near-point image increases as the frequency decreases (see FIG. 2B).

As described above, the frequency of an image is correlated with the subject distance, and in the far-point image, the high-frequency component is increased in a region having a long subject distance and the high-frequency component is decreased in a region having a short subject distance. Therefore, it is possible to calculate appropriate combining ratios for the respective regions R on the basis of the frequencies thereof.

Meanwhile, in a case in which the selected image A is the near-point image, in a scene of a lumen, the structure of a subject is dense in a region having a short subject distance, and the structure of the subject is rough in a region having a long subject distance. Therefore, in the relationship 7, the combining ratio of the near-point image increases as the frequency increases, and the combining ratio of the far-point image increases as the frequency decreases (see FIG. 2C).

As described above, the frequency of an image is correlated with the subject distance, and in the near-point image, the high-frequency component is decreased in a region having a long subject distance and the high-frequency component is increased in a region having a short subject distance. Therefore, it is possible to calculate appropriate combining ratios for the respective regions R on the basis of the frequencies thereof.

Although the processor 2 generates the determination map in this embodiment, alternatively, the processor 2 may execute processing for calculating the combining ratio for each region R without generating the determination map.

For example, as shown in FIG. 5, the processor 2 sets one region R in the image A, calculates a low-frequency component or a high-frequency component of the region R, and calculates a combining ratio for the region R on the basis of the low-frequency component or the high-frequency component. Subsequently, the processor 2 moves the region R in the image A and calculates a combining ratio for the region R after the movement. FIG. 5 shows an example in which the region R is scanned by a raster scan system. As described above, the processor 2 can calculate appropriate combining ratios for the respective regions R also by calculating a combining ratio for each region R while scanning the region R in the image A.

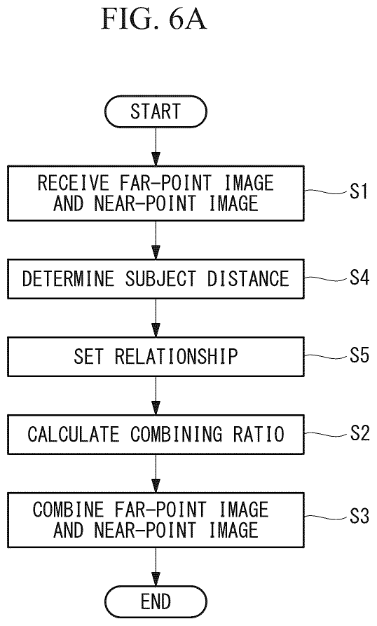

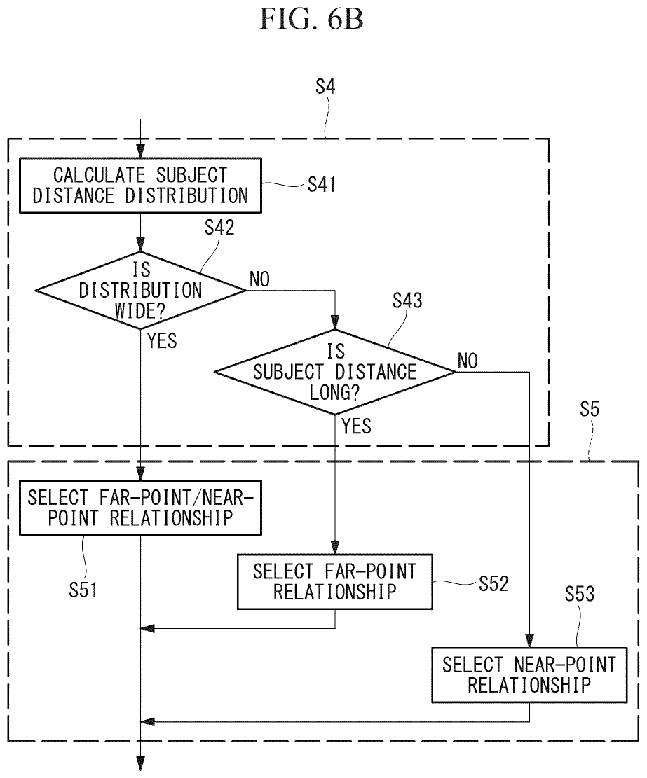

In the abovementioned embodiment, as shown in FIG. 6A, the processor 2 may determine subject distances in the far-point image or the near-point image (step S4), and may set the relationship 6, 7 to be used for calculating the combining ratio, in accordance with the subject distances (step S5).

Specifically, as shown in FIG. 6B, in step S4, the processor 2 determines a subject distance distribution on the basis of a brightness distribution of the image A (step S41). For example, the processor 2 calculates a histogram of the brightness of the image A. In a case in which the subject distance distribution is wide (for example, the image A includes both a short-distance subject and a long-distance subject), the brightness of the image A is distributed over a wide range, and a histogram having a large width is obtained. Meanwhile, in a case in which the subject distance distribution of the image A is narrow (for example, the image A includes only one of a short-distance subject and a long-distance subject), the brightness of the image A is distributed in a biased manner, and a histogram having a small width is obtained.

In the case in which the subject distance distribution is wide (for example, the width of the histogram is equal to or larger than a prescribed threshold) (YES in step S42), the processor 2 selects the far-point/near-point relationship 6 (step S51). As described above, the relationship 6 is a relationship between the brightness and the combining ratio. In this case, the processor 2 calculates the combining ratio on the basis of the brightness and the relationship 6 (step S2).

Meanwhile, in the case in which the subject distance distribution is narrow (for example, the width of the histogram is less than the prescribed threshold) (NO in step S42), the processor 2 subsequently determines whether or not the subject distances are long on the basis of the frequencies of both the far-point image and the near-point image (step S43). Specifically, the processor 2 calculates the high-frequency components of each of the far-point image and the near-point image, and compares the high-frequency components of the far-point image with the high-frequency components of the near-point image.

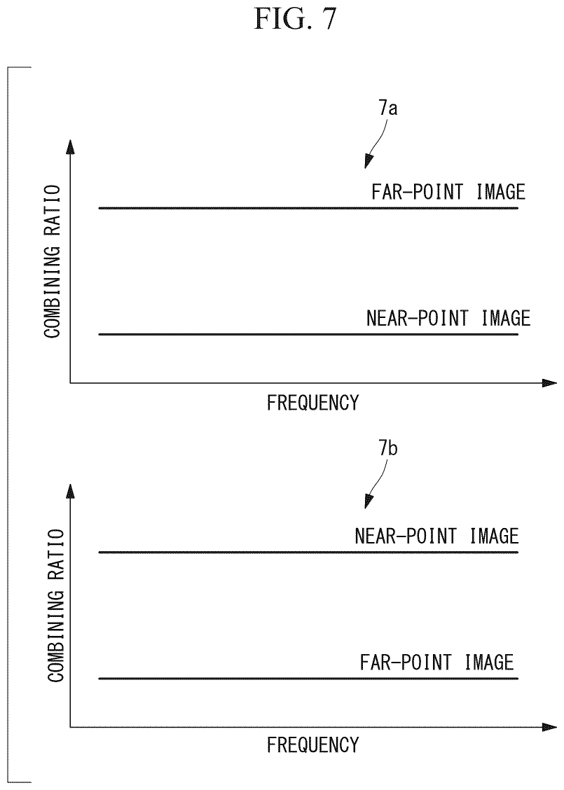

In a case in which the far-point image includes more high-frequency components than the near-point image, the processor 2 determines that the subject distances are long (YES in step S43), and selects a far-point relationship 7a (step S52). As shown in FIG. 7, the relationship 7a is a relationship between the frequency and the combining ratio, and in the relationship 7a, the combining ratios of the far-point image are higher than those of the near-point image over all the frequencies and, for example, the combining ratio of the far-point image is 100% over all the frequencies. In this case, the processor 2 calculates the combining ratio on the basis of the frequency and the relationship 7a (step S2). In the case in which the combining ratio of the far-point image is 100%, an EDOF+HDR image substantially consisting of the far-point image is generated (step S3).

Meanwhile, in a case in which the near-point image includes more high-frequency components than the far-point image, the processor 2 determines that the subject distances are short (NO in step S43), and selects a near-point relationship 7b (step S53). As shown in FIG. 7, the relationship 7b is a relationship between the frequency and the combining ratio, and in the relationship 7b, the combining ratios of the near-point image are higher than those of the far-point image over all the frequencies and, for example, the combining ratio of the near-point image is 100% over all the frequencies. In this case, the processor 2 calculates the combining ratio on the basis of the frequency and the relationship 7b (step S2). In the case in which the combining ratio of the near-point image is 100%, an EDOF+HDR image substantially consisting of the near-point image is generated (step S3).

During observation of the interior of a body cavity by means of the endoscope 10, a scene of an image changes, and the subject distance distribution also changes in accordance with the scene change. For example, in a scene in which a lumen is observed in a longitudinal direction as shown in FIG. 4A, the subject distance is distributed over a wide range from a short distance to a long distance. In a scene in which observation is performed by bringing the distal end of the endoscope 10 close to the inner wall of the body cavity, the subject distance distribution is biased only in the short-distance range.

With the image processing method shown in FIGS. 6A and 6B, the relationship 6, 7a, or 7b suitable for the scene of the image is set on the basis of the subject distance distribution. With this configuration, it is possible to calculate an appropriate combining ratio according to the scene and to generate a high-quality EDOF+HDR image.

After step S43, the processor 2 may output the far-point image or the near-point image as an EDOF+HDR image without performing steps S5, S2, and S3.

In addition, in the case in which the subject distance distribution is narrow, the subject distances are further determined on the basis of the frequencies. As a result of determining the subject distances on the basis of both the brightness and frequencies as described above, it is possible to robustly calculate appropriate combining ratios for various scenes.

In addition, the subject distance distribution is determined by using the brightness and frequencies of the far-point image and the near-point image. In other words, it is possible to determine the subject distances only through calculation processing without requiring a device such as a sensor for measuring the subject distance.

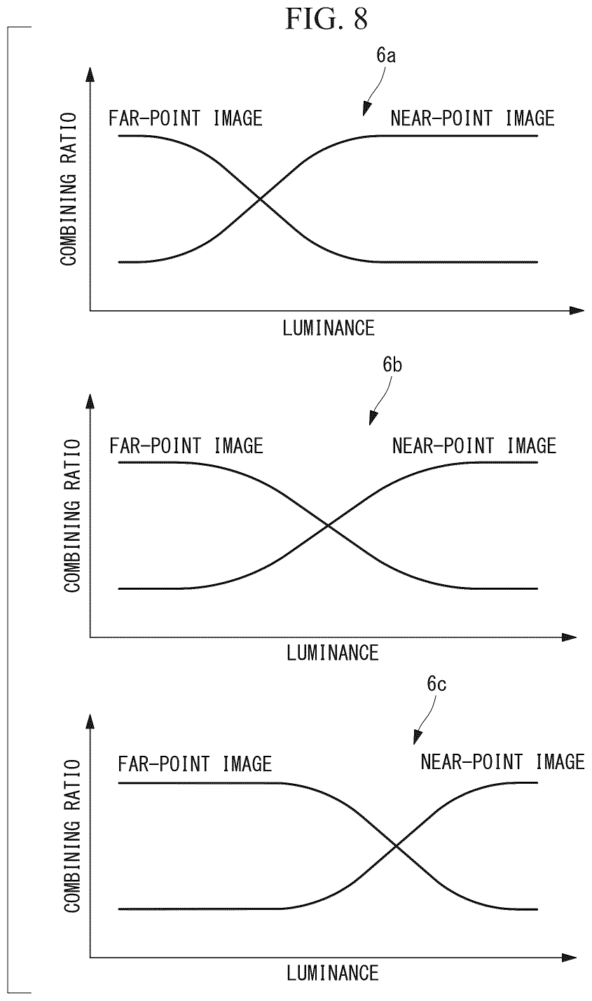

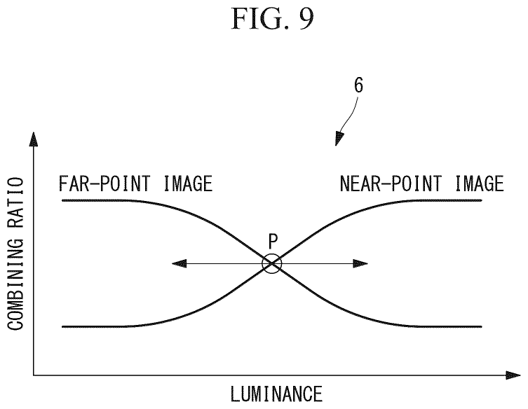

In the case in which the subject distance distribution is wide (YES in step S42), as shown in FIGS. 8 and 9, the processor 2 may set, in step S51, the relationship 6 in more detail in accordance with the subject distance distribution.

In a method shown in FIG. 8, the processor 2 selects one of a plurality of relationships 6a, 6b, 6c prepared in advance, for example, in accordance with the width of the histogram or the like. For example, in a case in which the histogram is biased to a bright region, the relationship 6a is selected.

In a method shown in FIG. 9, the processor 2 changes the relationship 6 in accordance with the width of the histogram or the like by moving an intersection P between the graph of the combining ratio of the far-point image and the graph of the combining ratio of the near-point image in the luminance direction. When the intersection P moves to the end of the graph, the relationship 6 becomes the relationship 7a or 7b shown in FIG. 7.

Although the embodiment of the present invention has been described above, the scope of the present invention is not limited thereto, and various improvements can be made within a range that does not depart from the spirit of the present invention. For example, the image processing device 1 may process a far-point image and a near-point image acquired by an imaging device other than the endoscope 10, such as a digital camera or a microscope, and may combine three or more images in which the focal distances and exposure amounts are different from each other to generate an EDOF+HDR image.

### REFERENCE SIGNS LIST

1 image processing device
2 processor
4 storage unit (recording medium)
6, 6a, 6b, 6c relationship between brightness and combining ratio
7, 7a, 7b relationship between frequency and combining ratio
A far-point image, near-point image
B determination map
R region

1. An image processing device comprising:
a processor, wherein the processor is configured to:
receive a far-point image focused at a far point and a near-point image focused at a near point, the far-point image and the near-point image having different exposure amounts from each other;
generate a determination map representing brightness or frequencies of respective regions of one of the far-point image and the near-point image;
calculate combining ratios of the far-point image and the near-point image for the respective regions on the basis of the determination map and a prescribed relationship between a combining ratio and brightness or a frequency; and
combine the far-point image and the near-point image by using the combining ratios calculated for the respective regions.

2. The image processing device according to claim 1, wherein the processor is configured to:
determine subject distances of the far-point image or the near-point image; and
set the relationship to be used for calculating the combining ratio, on the basis of the subject distances.

3. The image processing device according to claim 2, wherein the processor is configured to set the relationship by selecting one of a plurality of relationships in accordance with the subject distances.

4. The image processing device according to claim 2, wherein the processor is configured to set the relationship by changing a relationship between the combining ratio and the brightness or frequency in the relationship in accordance with the subject distances.

5. The image processing device according to claim 1, wherein the processor is configured to:
calculate low-frequency components of the one of the far-point image and the near-point image;
generate, as the determination map, a determination map representing the calculated low-frequency components; and
calculate the combining ratios for the respective regions on the basis of the determination map representing the calculated low-frequency components, and the relationship between the brightness and the combining ratio.

6. The image processing device according to claim 1, wherein the processor is configured to:
calculate high-frequency components of the one of the far-point image and the near-point image;
generate, as the determination map, a determination map representing the calculated high-frequency components; and
calculate the combining ratios for the respective regions on the basis of the determination map representing the calculated high-frequency components, and the relationship between the frequency and the combining ratio.

7. An image processing method comprising:
receiving a far-point image focused at a far point and a near-point image focused at a near point, the far-point image and the near-point image having different exposure amounts from each other;
generating a determination map representing brightness or frequencies of respective regions of one of the far-point image and the near-point image;
calculating combining ratios of the far-point image and the near-point image for the respective regions on the basis of the determination map and a prescribed relationship between a combining ratio and brightness or a frequency; and
combining the far-point image and the near-point image by using the combining ratios calculated for the respective regions.

8. A computer-readable non-transitory recording medium in which an image processing program is recorded,
wherein the image processing program causes a computer to execute:
receiving a far-point image focused at a far point and a near-point image focused at a near point, the far-point image and the near-point image having different exposure amounts from each other;
generating a determination map representing brightness or frequencies of respective regions of one of the far-point image and the near-point image;
calculating combining ratios of the far-point image and the near-point image for the respective regions on the basis of the determination map and a prescribed relationship between a combining ratio and brightness or a frequency; and
combining the far-point image and the near-point image by using the combining ratios calculated for the respective regions.
